(19) United States
(12) Patent Application Publication
(10) Pub. No.: US 2017/0139960 A1
(43) Pub. Date: May 18, 2017

(54) TABLE MIGRATION TO UPDATED STRUCTURES WITHOUT CREATING AN INTERMEDIATE COPY OF THE TABLE DATA

(71) Applicant: SAP SE, Walldorf (DE)

(72) Inventors: Andreas Lober, Wiesloch (DE); Florian Thomas, Schifferstadt (DE); Christiane Valentin, Malsch (DE); Wieland Hoprich, Mannheim (DE)

(21) Appl. No.: 14/945,192

(22) Filed: Nov. 18, 2015

(51) Int. Cl. G06F 17/30

(52) U.S. Cl. CPC G06F 17/30321; G06F 17/30289; G06F 17/30339

(57) ABSTRACT

A database definition language (DDL) description of a database table can be copied to create a temporary copy of the database table as part of a table upgrade to change a structure of the database table to an upgraded structure. The temporary copy of the database table can be renamed, and the DDL description in the temporary copy of the database table can be changed to an intermediate state while a runtime object and a database object of the database table remain in original states. The changed DDL description can be activated in the temporary copy of the database table such that the runtime object and the database object are updated to the intermediate state, and the temporary copy of the database table can be renamed to an original name of the database table, thereby activating the temporary copy as the database table with the upgraded structure.

### TECHNICAL FIELD

The subject matter described herein relates to performing updates to table structures in a database.

### BACKGROUND

When a table structure in a database (e.g. a database managed by a database management system or DBMS) undergoes a significant change, a typical approach involves a table conversion. In other words, a table of the target structure is generally created and filled with all data stored in columns with the same name in both the original structure and the new structure. Next, new columns are filled with default values before the old table is dropped and the new table is renamed to the original table name. X-persistent remote applications (XPRAs) or other data migration programs may work on the preserved and new columns.

Such an approach can include some inefficiencies. For example, temporary data duplication results from creation of the new table and migration of data from the original table. Additionally, data of renamed or deleted columns may be lost in the end and cannot be accessed during the conversion process. Furthermore, data duplication of very large tables is desirably avoided, particularly in an in-memory database environment in which expensive main memory is used for data storage and manipulation, but also in other database environments due to performance issues. The potential for data loss is generally unacceptable in any environment.

### SUMMARY

In one aspect, a method includes copying a database definition language description of a database table to create a temporary copy of the database table as part of a table upgrade to change a structure of the database table to an upgraded structure, renaming the temporary copy of the database table, changing the database definition language description in the temporary copy of the database table to an intermediate state while a runtime object and a database object of the database table remain in original states, activating the changed database definition language description in the temporary copy of the database table such that the runtime object and the database object are updated to the intermediate state, and renaming the temporary copy of the database table to an original name of the database table to thereby activate the temporary copy as the database table with the upgraded structure.

In some variations one or more of the following features can optionally be included in any feasible combination. The change to the database definition language description can include one or more of adding one or more fields for the new primary key, adding one or more fields for data to be included from other tables, and adding one or more fields for data from multi-purpose fields. The activating of the change can include one or more of filling new primary key fields, splitting up data from multi-purpose fields and distributing them over their target fields, and including data from other tables. The activating of the temporary copy can include one or more of dropping an old primary key from the database, adapting the database definition language description to one or more new key fields, creating a new primary key, and removing obsolete fields. The activating of the temporary copy can affect only the runtime object, because the database table already has its target structure. The database definition language description can include an Advanced Business Application Programming language description of the database table.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a database management system, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram of a computing architecture for a database management system consistent with implementations of the current subject matter;

FIG. 2 shows a table listing examples of logical changes in database fields and the resultant transformations in table structure that can be required to avoid implementation of complex application logic;

FIG. 3 shows a diagram illustrating examples of table clean-up operations that can be required to effect a structural change to a table; and

FIG. 4 shows a diagram illustrating an approach to upgrading a table structure consistent with implementations of the current subject matter.

When practical, similar reference numbers denote similar structures, features, or elements.

### DETAILED DESCRIPTION

Implementations of the current subject matter can provide one or more technical advantages relative to currently available approaches. For example, a table structure can be changed in-place (i.e. without data duplication), data in obsolete columns can be temporarily kept (e.g. to allow for calculation of data for new columns derived from data of all columns from the original table structure), a table's primary key can be changed in-place, and the like.

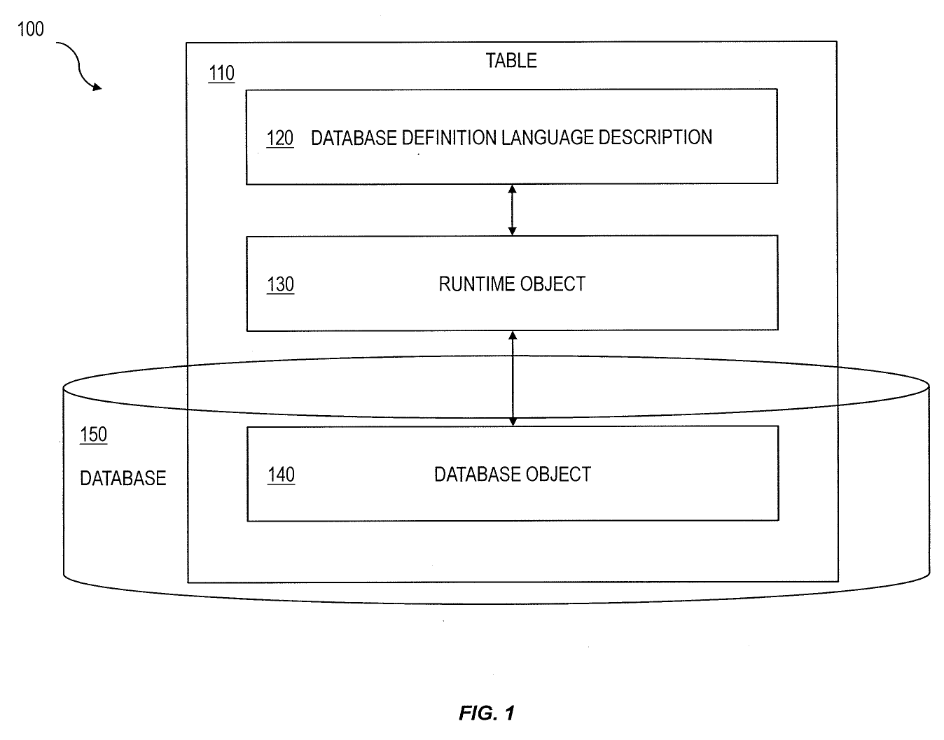

Database definition languages, such as for example the Advanced Business Application Programming (ABAP) language available from SAP SE of Walldorf, Germany can include creation of a description of every table in a database in the database definition language (referred to herein as a DDIC definition), a DDIC runtime object, and an object description stored in a catalog of the database. FIG. 1 shows a diagram 100 illustrating an example of these three layers of a typical database. As shown, a table 110 includes a database definition language description 120 of its structure (DDIC definition), a runtime object 130, and an object description 140 in a database catalog 150 of the database. The database 150 can be implemented as part of a database management system, which can include one or more programmable processors executing database management operations and one or more persistent memories and/or main memory data stores in which tables, objects, and the like are persistently and/or temporarily stored. During routine operations with the table, these three object descriptions are generally in sync (e.g. the DDIC definition 120, the runtime object 130, and the database object 140 in the database catalog 150 need to match). However, during a system or software upgrade, there may be old and new versions of a table in the DDIC.

Upgrading a database application (e.g. an application running in an enterprise resource management system or other business software architecture) can require a change of a table structures. Simple structure changes may result in executions of data definition language (DDL) statements on the database, and can generally have a small memory footprint, and rather short runtimes. In contrast, complex structure changes generally cannot be performed directly on the database level, for example because they result in a conversion of a table. Complex structure changes such as this may require that data are copied from the original table with the old structure (also referred to as original table A) into a new table with the new structure (referred to as table A′). Afterwards table A is dropped, and table A′ is renamed to A.

A conversion to implement a structural change performed using previously available approaches can result in long runtimes and large space requirements. Therefore, some database management system may prohibit significant changes to a table structure for tables holding large amounts of data. Under such a prohibition, structural changes may be avoided by creating new columns as additions to the table but without dropping the old ones. However, this type of workaround generally requires that the application logic address the added table complexity, which can result in less than optimal performance.

Avoidance or reduction of such poor table structures can require implementation of significant structural change, which, as noted above, can result in long runtimes, temporary data duplication, or (in very undesirable cases) data loss if such changes are performed using conventional approaches.

One example of a structural change that is not well-addressed by currently available approaches includes conversion of a column having a data type of “numerical character of fixed length with leading zeroes” (NUMC). If a NUMC field turns out to be too small for data required to be stored in it, it can be necessary to increase the length of the NUMC field. Regular DDL statements generally do not support such an increase or enlargement in the size of a NUMC field. For example, there is generally no intrinsic database logic for adding new leading zeroes to existing data in a column while increasing the field length. Therefore a table conversion can be required to effect this change. The table conversion typically includes copying the original table to a table having the new structure with its data transformed accordingly. After the copying to the new table, the old table is dropped and the new table renamed to the original name. Such an approach can require having both the original and the new table loaded into memory at the same time, thereby consuming twice as much memory as loading the original version of the table alone.

A currently available workaround that can avoid the need for such a conversion is to add a new and longer NUMC field to the structure and merge the old and new values via application logic. This can be undesirable for various reasons including, but not limited to, added processing demands and complexity of application programming.

Another example of a structural change that may not be well-addressed by currently available approaches can include extending the primary key of a table. While a new primary key and an old primary key field are typically simple data fields, adding new fields to a primary key is typically not supported as a DDL operation due to various restrictions or limitations in the DDL. As an example, ABAP does not support such changes. When the primary key is changed, a table conversion can be required. A potential workaround to structurally changing the table by adding new fields to the primary key is to add the information into an already existing field. This results in multi-purpose fields. As with the NUMC example above, the application would then be required to handle this by special logic, resulting in complex algorithms and lower performance.

A third example in which a structural change or processing-intensive workaround may be required includes creating one-to-one references between tables. In some DBMS architectures, it is not allowed to extend a table A with additional fields. Accordingly, a new table B is created for the additional fields. A field of table A only has a reference to table B containing the required data in a 1-to-1 relation. To see complete data records, expensive joins are needed.

A similar issue can arise with references to an external table from within a database table. For performance reasons, it can be preferable to create a new table that includes the external data incorporated into a new table to eliminate the references to the external table such that it is no longer necessary for a database application to perform a join operation.

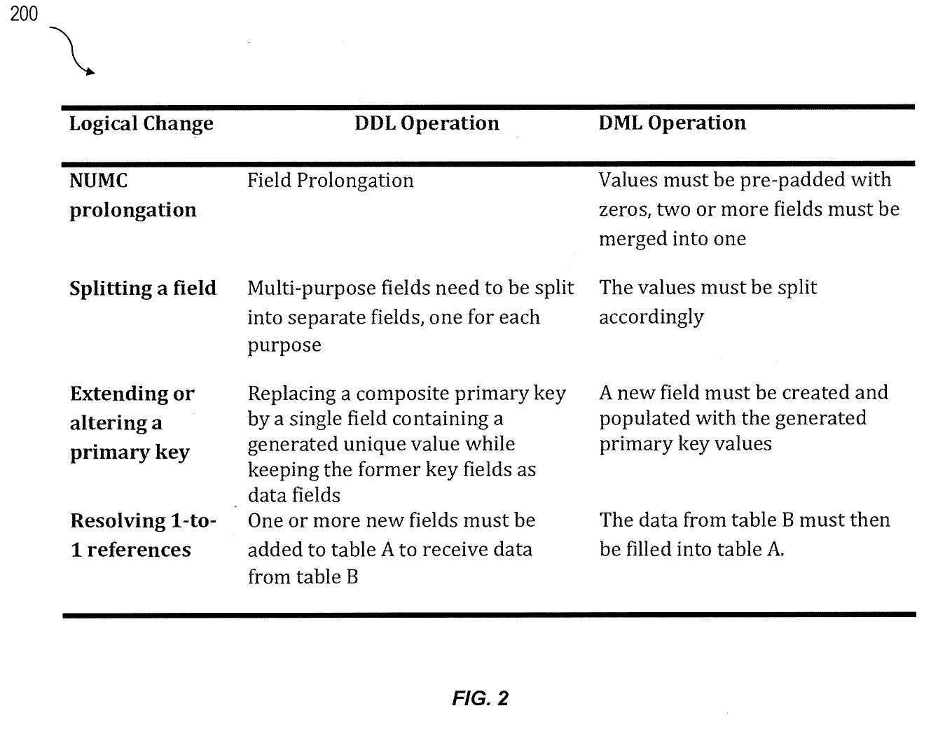

The table 200 of FIG. 2 provides a summary of examples of types of structural changes that can be required to avoid requiring a database application layer to handle complicated, processor intensive logic.

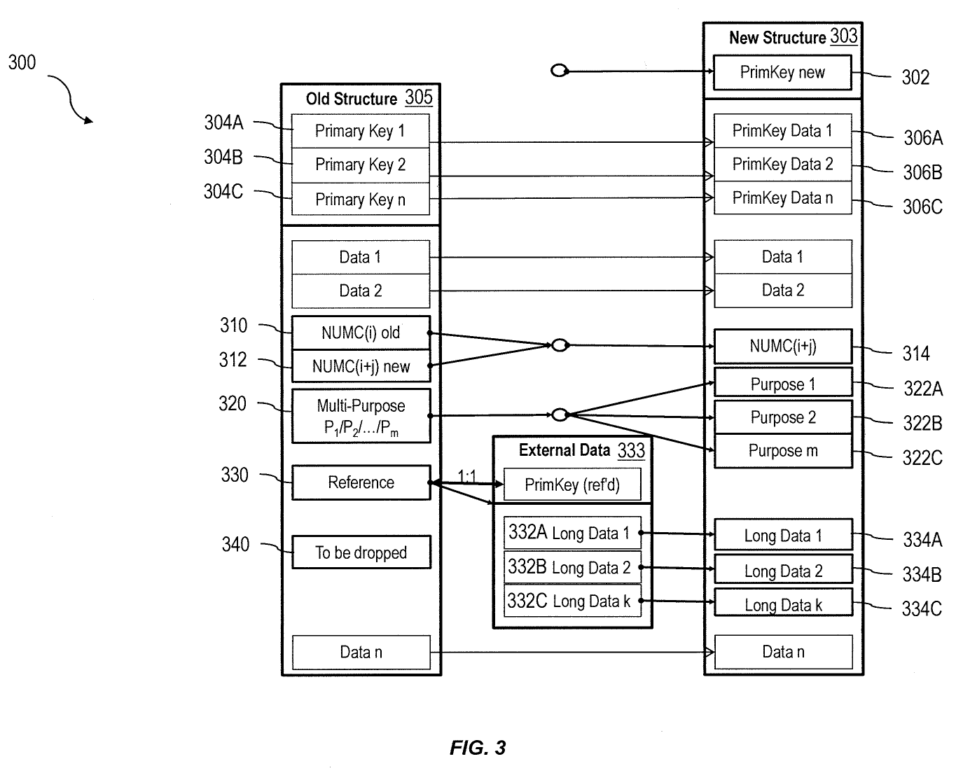

FIG. 3 shows a diagram 300 illustrating examples of table clean-up operations that can be required using existing approaches to implementing a structural change to a table. For example, the diagram 300 shows the creation of a new primary key 302 in a new structure 303 while multiple primary key fields 304A, 304B, 304C in an old structure 305 are converted to data fields 306A, 306B, 306C in the new structure. The diagram 300 also shows and “old NUMC field 310 and a “new” NUMC field 312 of a longer length, both in the old structure 305 being combined into a single NUMC field 314 in the new structure 303. A single multipurpose field 320 in the old structure 305 can be split into multiple single purpose fields 322A, 322B, 322C in the new structure 303. A reference field 330 in the old structure 303 to data fields 332A, 332B, 332C in an external table 333 can be converted to included fields 334A, 334B, 334C in the new structure 303. Also, a field to be dropped 340 can be omitted from the new structure 303.

As noted, currently available approaches can include first applying the structural changes to the DDIC definition (e.g. the database definition language description 120 of the structure of the table), which are propagated to the other layers 130, 140 to create a new table with an updated table structure. One or more DDL statements (e.g. ALTER TABLE, ADD COLUMN, DROP COLUMN, CHANGE COLUMN, or DDL+DML statements like CREATE TABLE AS SELECT, are generated to allow working on data at the end, after the table in the database has been updated to the target structure. As it is generally not possible to include old data into calculations of new data, there is a potential for data loss, which can generally be avoided only by forbidding greater restructuring of the table. In addition, as noted above, data duplication (CREATE TABLE AS SELECT) can be an issue in an in-memory environment. Additionally, this approach generally does not allow splitting of a field or combining of two or more fields into one.

Consistent with implementations of the current subject matter, an improved approach to updating a table structure can include create a temporary copy of the table definition object, and then renaming the database table so that data copying is not required. Instead only the DDIC definition of the table is copied and then defined with the updated structure. The original DDIC definition object no longer has an associated table during this process.

During a table upgrade (e.g. a structure change), a temporary copy (TAB_TMP) of the original table (TAB) is created in the DDIC environment. The temporary copy is in the original pre-upgrade state. The database table itself is not read by applications in this phase of the upgrade, it does not need to be copied, but can be renamed (to TAB_TMP). The DB table is then renamed; the DDIC definition is changed to reflect any new fields; the changes are activated to the runtime and database objects; and finally, the table object is renamed, the key is changed, obsolete fields are removed, and the updated table is activated.

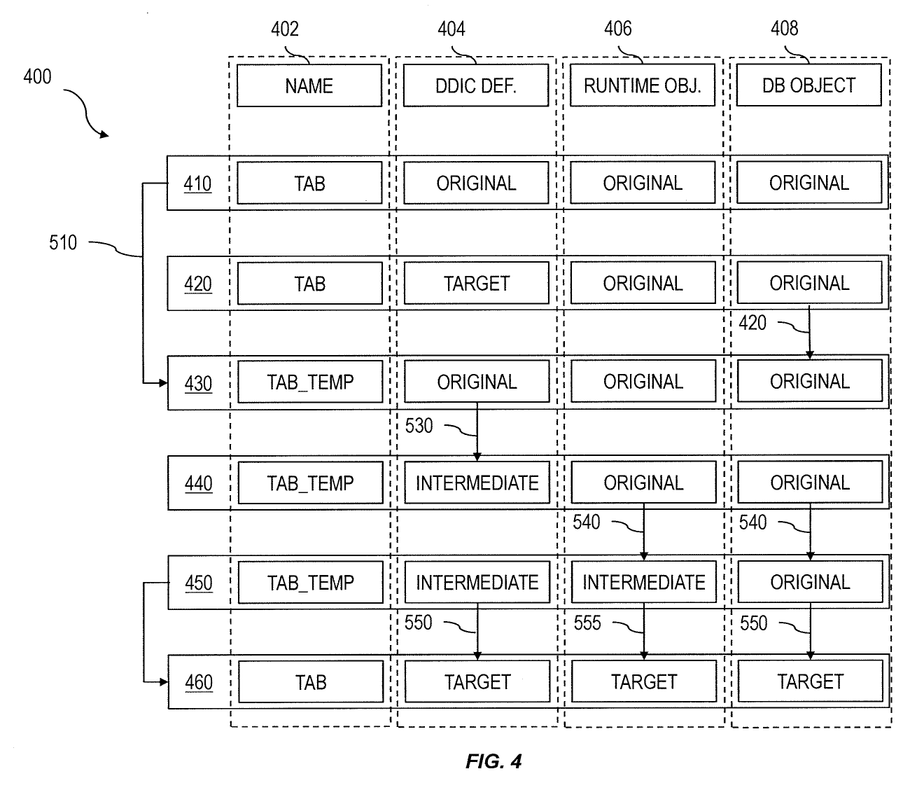

Details of this process may be further understood by reference to the diagram 400 of FIG. 4, in which the vertical columns indicate a name 402 of a table (e.g., TAB or TAB_TMP), a DDIC definition status 404 of the table (e.g. original, target, or intermediate), a runtime object status 406 of the table (e.g. original, target, or intermediate), and a database object status 408 of the table. The horizontal rows in the FIG. 4 illustrate states of the table at each stage of the process. The first row 410 depicts a pre-upgrade state of the table (“TAB”) with the DDIC definition 404, the runtime object 406, and the database object 408 all in an original state. At operation 510 of the upgrade process, the DDIC definition 404 for the table is copied, thereby creating a temporary copy TAB_TMP of the table (designated as the third row 430 in FIG. 4), while the database table is renamed at 520. The DDIC definition 404 in the original table TAB (designated as the second row 420 in the FIG. 4) is updated to the target state. The runtime object 406 and the database object 408 of the original table TAB remain in their original state.

At 530, the DDIC definition 404 in the temporary copy TAB_TMP is changed to an intermediate state (as shown in the fourth row 440 of FIG. 4) while the runtime object 406 and the database object 408 remain in their original state. The change to the DDIC definition can include one or more of adding one or more fields for the new primary key, adding one or more fields for data to be included from other tables, and adding one or more fields for data from multi-purpose fields.

At 540, the change is activated in the temporary copy TAB_TMP and the data are worked on as necessary such that the runtime object 406 and the database object 408 are updated to the intermediate state (e.g. to bring the runtime object and the database table in sync with the DDIC definition) as indicated in the fifth row 450 of FIG. 4. The activating of the change can include one or more of filling new primary key fields, splitting up data from multi-purpose fields and distributing them over their target fields, and including data from other tables.

At 550, the temporary copy of the table is renamed to the table's original name and the temporary copy TAB_TMP is thereby activated as the table TAB (indicated in the sixth row 460 of FIG. 4). The activating can include one or more of dropping the old primary key from the database (the affected fields are now data fields), adapting the DDIC definition 404 to new key fields, creating a new primary key, removing obsolete fields. The activating affects only the runtime object, since the database table already has its target structure.

The current subject matter can provide one or more technical benefits. For example, a strict database definition language (e.g. ABAP or the like)-based table upgrade procedure can be split up to include the ability to incorporate additional data processing logic. This extra data processing logic need not be restricted to database definition language-only code but can also include direct SQL and stored procedures.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like. Other display devices can include heads up or holographic displays.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for implementation by one or more data processors forming part of at least one computing system, the method comprising:
copying a database definition language description of a database table to create a temporary copy of the database table as part of a table upgrade to change a structure of the database table to an upgraded structure;
renaming the temporary copy of the database table;
changing the database definition language description in the temporary copy of the database table to an intermediate state while a runtime object and a database object of the database table remain in original states;
activating the changed database definition language description in the temporary copy of the database table such that the runtime object and the database object are updated to the intermediate state; and
renaming the temporary copy of the database table to an original name of the database table and thereby activating the temporary copy as the database table with the upgraded structure.

2. A method as in claim 1, wherein the change to the database definition language description comprises one or more of adding one or more fields for the new primary key, adding one or more fields for data to be included from other tables, and adding one or more fields for data from multi-purpose fields.

3. A method as in claim 1, wherein the activating of the change comprises one or more of filling new primary key fields, splitting up data from multi-purpose fields and distributing them over their target fields, and including data from other tables.

4. A method as in claim 1, wherein the activating of the temporary copy comprises one or more of dropping an old primary key from the database, adapting the database definition language description to one or more new key fields, creating a new primary key, and removing obsolete fields.

5. A method as in claim 1, wherein the activating of the temporary copy affects only the runtime object, because the database table already has its target structure.

6. A method as in claim 1, wherein the database definition language description comprises an Advanced Business Application Programming language description of the database table.

7. A computer program product comprising a non-transient machine-readable medium storing instructions that, when executed by at least one programmable processor, cause the at least one programmable processor to perform operations comprising:
copying a database definition language description of a database table to create a temporary copy of the database table as part of a table upgrade to change a structure of the database table to an upgraded structure;
renaming the temporary copy of the database table;
changing the database definition language description in the temporary copy of the database table to an intermediate state while a runtime object and a database object of the database table remain in original states;
activating the changed database definition language description in the temporary copy of the database table such that the runtime object and the database object are updated to the intermediate state; and
renaming the temporary copy of the database table to an original name of the database table and thereby activating the temporary copy as the database table with the upgraded structure.

8. A computer program product as in claim 7, wherein the change to the database definition language description comprises one or more of adding one or more fields for the new primary key, adding one or more fields for data to be included from other tables, and adding one or more fields for data from multi-purpose fields.

9. A computer program product as in claim 7, wherein the activating of the change comprises one or more of filling new primary key fields, splitting up data from multi-purpose fields and distributing them over their target fields, and including data from other tables.

10. A computer program product as in claim 7, wherein the activating of the temporary copy comprises one or more of dropping an old primary key from the database, adapting the database definition language description to one or more new key fields, creating a new primary key, and removing obsolete fields.

11. A computer program product as in claim 7, wherein the activating of the temporary copy affects only the runtime object, because the database table already has its target structure.

12. A computer program product as in claim 7, wherein the database definition language description comprises an Advanced Business Application Programming language description of the database table.

13. A system comprising:
computer hardware comprising at least one programmable processor configured to perform operations comprising:
copying a database definition language description of a database table to create a temporary copy of the database table as part of a table upgrade to change a structure of the database table to an upgraded structure;
renaming the temporary copy of the database table;
changing the database definition language description in the temporary copy of the database table to an intermediate state while a runtime object and a database object of the database table remain in original states;
activating the changed database definition language description in the temporary copy of the database table such that the runtime object and the database object are updated to the intermediate state; and
renaming the temporary copy of the database table to an original name of the database table and thereby activating the temporary copy as the database table with the upgraded structure.

14. A system as in claim 13, wherein the change to the database definition language description comprises one or more of adding one or more fields for the new primary key, adding one or more fields for data to be included from other tables, and adding one or more fields for data from multi-purpose fields.

15. A system as in claim 13, wherein the activating of the change comprises one or more of filling new primary key fields, splitting up data from multi-purpose fields and distributing them over their target fields, and including data from other tables.

16. A system as in claim 13, wherein the activating of the temporary copy comprises one or more of dropping an old primary key from the database, adapting the database definition language description to one or more new key fields, creating a new primary key, and removing obsolete fields.

17. A system as in claim 13, wherein the activating of the temporary copy affects only the runtime object, because the database table already has its target structure.

18. A system as in claim 13, wherein the database definition language description comprises an Advanced Business Application Programming language description of the database table.
